(19) United States
(12) Patent Application Publication
(10) Pub. No.: US 2007/0061508 A1
(43) Pub. Date: Mar. 15, 2007

(54) Data storage cartridge with built-in tamper-resistant clock

(75) Inventor: James Zweighaft, Boulder, CO (US)

Correspondence Address: MORRISON & FOERSTER LLP, 755 PAGE MILL RD, PALO ALTO, CA, 94304-1018, US

(73) Assignee: Quantum Corporation, San Jose, CA (US)

(21) Appl. No.: 11/226,809

(22) Filed: Sep. 13, 2005

(51) Int. Cl. G06F 12/00

(52) U.S. Cl. 711/111

(57) ABSTRACT

A data cartridge contains a battery powered clock that can be read by a media drive. The clock's value is written to the tape as a timestamp, and the timestamp is associated with a data set. The drive is designed such that the clock's value cannot be altered by the host system before being written to the tape. For further security, a confirmation value may be generated based upon the data set and the clock's value. The confirmation value is written to the tape in association with the data set and time stamp. Subsequent modification of the data set can be detected by retrieving the confirmation value from the storage medium, calculating a new confirmation value based upon the data set's current contents, and comparing the two confirmation values. If the two values are not equal, then the data set has been modified since the time represented by the timestamp.

### BACKGROUND

1. Field of the Invention

The present invention relates generally to methods and systems for detecting changes to a data set stored on a storage medium, and more specifically to such methods and systems for verifying that a data set stored on a magnetic storage medium has not changed since a certain date.

2. Description of the Related Art

Data stored on data storage media such as magnetic tape can be overwritten with different data at any time. It is desirable, however, to be able to show or indicate that data was written at a certain date and has not been modified since that date. For example, financial transaction records stored on a computer system could be modified to change the dollar amounts involved by overwriting the amounts stored on magnetic tape with different amounts. Existing data protection methods include write-protect switches and various append-only schemes. Additionally, optical media provides write-once capability.

It would be desirable to be able to provide a guarantee that data in a storage medium has not been tampered with since a date in the past when it was known to be legitimate.

### SUMMARY OF THE INVENTION

In general, in a first aspect, the invention features a media carrier having a storage medium, clock logic for generating a time value readable by a media drive, and a battery for powering the clock logic. Embodiments of the invention may include one or more of the following features. The media carrier may have a memory that may store a confirmation value based upon a data set. The clock logic may include a clock that is not resettable by a user of the media carrier and a battery for powering the clock for at least 1 year. The memory may be nonvolatile, and may be a Programmable Read-Only Memory (PROM). The storage medium may be magnetic and/or optical tape.

In a second aspect, the invention features a media drive for operation with a media carrier, the media carrier including clock logic for generating a time value. The media drive has time stamp recording logic for reading the time value from the media carrier and writing the time value to a storage medium associated with the media carrier to create a time stamp on the storage medium. The time stamp is associated with a data set written to the storage medium. Embodiments of the invention may include one or more of the following features. The time stamp may be based upon the time the data set is written to the storage medium. The media drive may have confirmation value generation logic for generating a confirmation value based upon the data set, and confirmation value recording logic for writing the confirmation value to the storage medium. The confirmation value may be associated with the data set on the storage medium. The media drive may have confirmation value storage logic for storing the confirmation value in a memory associated with the media carrier. The confirmation value memory location may be associated with the data set. The confirmation value may be based upon the data set and the time stamp, and may be generated by a function of the data set and the time stamp, such as a Cyclic Redundancy Check (CRC) function of the data set.

The media drive may include tamper detection logic for comparing a current confirmation value generated by the confirmation value generation logic based upon a data set stored on the storage medium to a stored confirmation value read from the storage medium, where the stored confirmation value is associated with the data set. The media drive may include tamper detection logic for comparing a current confirmation value generated by the confirmation value generation logic based upon a stored data set stored on the storage medium to a stored confirmation value read from the confirmation value memory location. The media drive may include tamper reporting logic for reporting tampering if the current confirmation value is not equivalent to the stored confirmation value.

In a third aspect, the invention features a tape cartridge having a tape, a battery, a battery-powered clock for generating a time value, and a drive interface for sending the time value to a tape drive. Embodiments of the invention may include one or more of the following features. In one example, the tape cartridge may have a memory for storing a confirmation value.

In a fourth aspect, the invention features a tape drive for operation with a tape cartridge, the tape cartridge including clock logic for generating a time value. The tape drive has a cartridge interface for receiving a time value from a tape cartridge and time stamp recording logic for writing the time value to the storage medium to create a time stamp. The time stamp is associated with a data set written to the storage medium. Embodiments of the invention may include one or more of the following features. The tape drive may have confirmation value generation logic for generating a confirmation value based upon the data set. The tape drive may have confirmation value recording logic for writing the confirmation value to the tape, where the confirmation value is associated with the data set. The tape drive may have confirmation value storage logic for sending the confirmation value to the tape cartridge via the cartridge interface. The confirmation value may then be stored in the confirmation value memory location of the tape cartridge.

In a fifth aspect, the invention features a method for storing a data set on a storage medium. The storage medium is associated with a media carrier. The method includes the steps of reading a time value from clock logic associated with the media carrier, writing the time value the storage medium, and writing the data set to the storage medium, where the data set is associated with the time stamp. Embodiments of the invention may include one or more of the following features. The method for storing a data set on a storage medium may also include the steps of generating a confirmation value based upon the data set and writing the confirmation value to the storage medium.

In a sixth aspect, the invention features a method for determining when a data set was written to a storage medium, including the step of reading a time stamp associated with the data set from the storage medium. Embodiments of the invention may include one or more of the following features. The method for determining when a data set was written to a storage medium may include the steps of generating a current confirmation value based upon the data set, retrieving a stored confirmation value from a memory, comparing the current confirmation value to the stored confirmation value, and, if the values are equivalent, reporting that the data set was written at the time corresponding to the time stamp.

The present invention and its various embodiments are better understood upon consideration of the detailed description below in conjunction with the accompanying drawings and claims.

### BRIEF DESCRIPTION OF THE DRAWINGS

FIG. 1 is an illustrative drawing of a storage system according to one embodiment of the invention.

FIG. 2 is a flowchart illustrating a method of writing data to a storage medium according to one embodiment of the invention.

FIG. 3 is a flowchart illustrating a method of writing data to a storage medium according to one embodiment of the invention.

FIG. 4 is a flowchart illustrating a method of checking for modification of stored data according to one embodiment of the invention.

FIG. 5 is an illustrative drawing of a data set and associated values stored on a storage medium according to one embodiment of the invention.

### DETAILED DESCRIPTION OF A PREFERRED EMBODIMENT

The following description is presented to enable any person skilled in the art to make and use the invention, and is provided in the context of particular applications and their requirements. Various modifications to the preferred embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

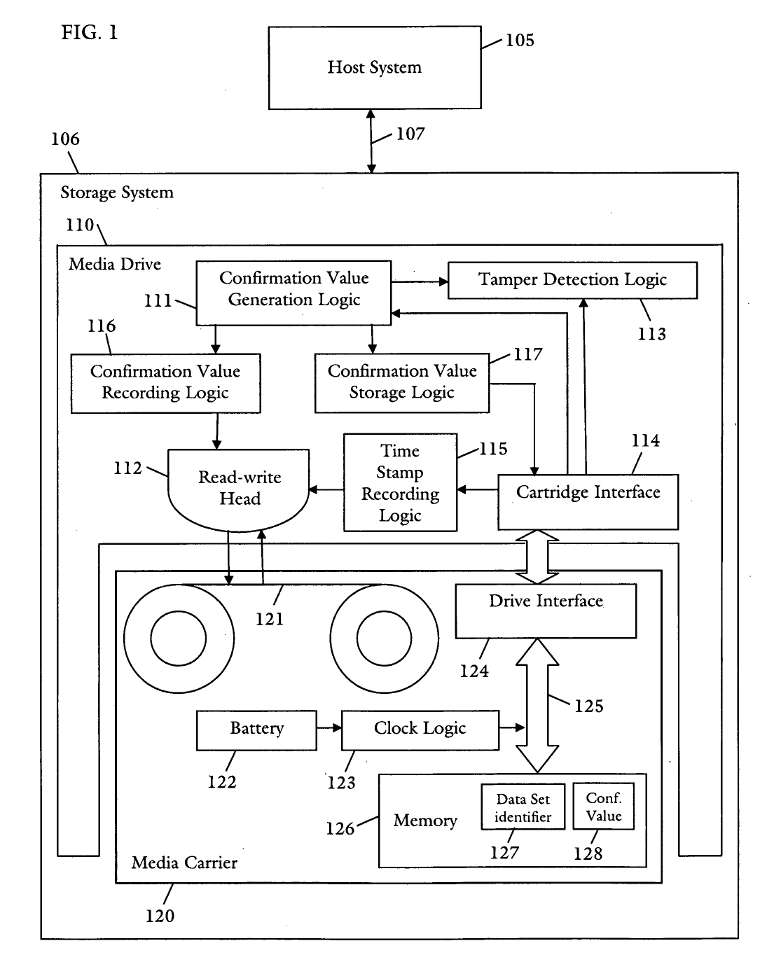

FIG. 1 is an illustrative drawing of a storage system 106 according to one embodiment of the invention. The storage system 106 is, for example, a tape library, and may include at least one media drive 110. A media drive 110 is, for example, an electromechanical device such as a tape drive that directly controls, writes to, and reads from a storage medium 121, such as a tape housed in a removable media carrier 120. According to one example, the media drive 110 may be a disk drive that directly controls, writes to, and reads from the storage medium 121 in the form of a magnetic or optical disk or the like. The storage system 106 may be coupled to a host system 105, which transmits input/output requests to the storage system via a host/storage communication link 107. The host system 105 may be, for example, a computer which communicates with the media drive 110 and provides a data set to be stored on the media drive 110. The media carrier 120 may be, for example, a cartridge or a cassette. The media carrier 120 may house a storage medium 121, a clock 123, a drive interface 124, and a memory 126. The clock 123 may be non-resettable, i.e. read-only, and may be powered by a long lasting battery 122, e.g., lithium or the like, so that the clock 123 will run for a long period of time, e.g., 1 year or more. The memory 126 may be nonvolatile, e.g., EEPROM or the like. The media carrier's drive interface 124 communicates with a cartridge interface 114 housed in the media drive 110 to allow the media drive 110 to read the clock 123 and the memory 126, and write to the memory 126. The drive interface 124 and cartridge interface 114 may communicate by, for example, infrared signals, radio frequency (RF) signals, or direct wire connection.

The media drive 110 may include a cartridge interface 114 for reading data values, such as the clock's value, from the media carrier 120, and a read/write head 112 for reading and writing data to and from the storage medium 121. The media drive 110 includes time stamp recording logic 115 for receiving values, such as a time value generated by the clock 123, from the cartridge interface 114, and writing the values to the storage medium 121 via the read/write head 112. The media drive 110 may include confirmation value generation logic 111 for generating a confirmation value based upon a data set read from the storage medium 121. The media drive 110 may also include confirmation value recording logic 116 for writing a confirmation value to the storage medium 121 via the read/write head 112. The media drive 110 may also include confirmation value storage logic 117 for storing a confirmation value in memory 126. The confirmation value and associated logic are described in more detail below.

The clock 123 provides a tamper-resistant source of time values and enables time-stamping of data sets. A time stamp is typically a time value read from the clock 123 and stored on the storage medium 121.

A time value is a value that directly or indirectly specifies an instant in time. A time value may be, for example, a value relative number of units since some well-known epoch date, e.g., a number of seconds since Jan. 1, 1970. A time value may alternatively be an absolute value, such as May, 21, 2000 14:20.22. A time value may specify the time a desired accuracy, e.g., seconds or days. A time value may also be represented as a counter value that represents a point in time in some other units, or may be a value that can be used to indirectly identify an instant in time. An indirect time value may be, for example, an index value that identifies an entry in a table, and the table entry contains a direct time value.

A time stamp is a time value stored along with any other desired information on the storage medium 121 or in the memory 126, from which the time stamp can be retrieved at a later time. The time stamp typically corresponds to the time at which it was stored. A time stamp can be used to determine, directly or indirectly, as described above for time values, the time at which the time stamp was written to the storage medium 121 or to the memory 126.

The action of time-stamping a data set includes storing a time value in association with the data set. Data sets may be time-stamped with the clock's value at the time they are stored. For example, the media drive 110 may write the clock's value to the storage medium 121 as part of a data set, or as a value associated with a data set. The time stamp may be retrieved by, for example, reading the data set or by reading a header or table associated with the data set. The time stamp may be retrieved at any time after it is written, as long as it has not been overwritten or erased. The time stamp provides a tamper-resistant indication of when the associated data set was written. If the clock 123 were to stop running, all previous writes to the storage medium 121 would remain time stamped on the storage medium 121 itself and would still be valid.

At least one data set may be stored on a storage medium 121, and each data set may be identified by a data set identifier. A data set may be a file, specified by a file identifier, in which case the confirmation value is calculated as a function of the file data and the time stamp value read from the clock 123 in the media carrier 120. Multiple data sets residing on a single storage medium 121 may be associated with corresponding confirmation values, in which case a data set identifier, such as a file name, may be specified for each data set. The memory 126 may have one or more data set identifier memory locations 127 and confirmation value memory locations 128. Each data set identifier memory location 127 may be associated with a confirmation value memory location 128, thereby establishing an association between a data set identified by a data set identifier and a confirmation value.

With reference to FIG. 1, whenever the host system 105 sends a data set to the media drive 110 to be written to the storage medium 121, the media drive 110 receives a time value from the clock 123 in the media carrier 120 and writes the time value to the storage medium 121 along with the data set. This process of writing the time stamp with the data set is performed automatically by the media drive 110 in cooperation with the media carrier 120, so the host system 105 cannot tamper with the time stamp. When the data set is subsequently read from the storage medium 121, the media drive 110 reads the recorded time stamp from the storage medium 121 along with the data set, and provides the time stamp to the host system 105 along with the data set. Therefore the recorded time stamp provides some measure of certainty to the host system 105 or a user (not shown) that the data set was written at the time specified by the time stamp.

For additional security, a confirmation value such as a Cyclic Redundancy Check (CRC) value may be generated based upon a combination of the original data set and a time value read from the media carrier 120. In this case, with respect to FIG. 1, a time value is read from the clock 123 and transferred to the confirmation value generation logic 111 via the read/write bus 125, the drive interface 124, and the cartridge interface 114. The confirmation value is then stored in the memory 126 by the confirmation value storage logic 117 in one example. In another example, the confirmation value is written to the storage medium 121 by the confirmation value recording logic 116. This confirmation value is referred to herein as a stored confirmation value and can be represented as a function of the data set as written and the time stamp:
StoredConfirmationValue=CRC(DataSetAsWritten, TimeStamp)
where CRC is a function such as a Cyclic Redundancy Check or a cryptographic hash function (e.g., the MD5 Message Digest function commonly used in data security applications) that generates a unique value for its arguments, and DataSetAsWritten and TimeStamp are the data set and time stamp written to the storage medium 121, respectively. For example, the CRC function may concatenate the data values specified by its arguments together into a single combined value and generate a unique value for the single combined value.

When the data set is subsequently read from the storage medium 121, the media drive 110 reads the recorded time stamp from the storage medium 121 along with the recorded data set. The media drive 110 also reads the stored confirmation value that was previously stored in memory 126 (according to one example) or on the storage medium 121 (according to another example). Next, the media drive 110 calculates a current confirmation value based upon the recorded time stamp and recorded data set. The current confirmation value is calculated as:
CurrentConfirmationValue=CRC(DataSetAsRead, TimeStamp)
where DataSetAsRead and TimeStamp are the recorded data set and recorded time stamp read from the storage medium 121, respectively.

The authenticity of the recorded time stamp can now be verified. If the stored confirmation value is equivalent to the current confirmation value (e.g., StoredConfirmationValue=CurrentConfirrnationValue), then the recorded time stamp provides a strong measure of certainty to the host system 115 or user that the data set was written at the time specified by the recorded time stamp. Those skilled in the art will appreciate that it would be difficult to alter the combined data set so as to derive an identical confirmation value. Thus, the confirmation value effectively becomes a digital signature of the combined data set and can be stored in the nonvolatile memory of the media carrier 120. Because the time stamp is automatically read from the media carrier 120, it would be difficult for a person with fraudulent intent to modify the time stamp during the process of writing the data set. The confirmation value comparison detects any change made to the data since a recorded or stored confirmation value was generated. Changes that may be detected include, for example, changes written by the media drive 110, changes written by a different media drive (not shown) not equipped with the apparatus described herein, or changes induced by a magnetic field from any other source.

With respect to FIG. 1, to check if tampering has occurred for a data set, e.g., in response to a request from the host system 105, or as a routine step in retrieving a data set, the data set is read from the storage medium 121 using the read/write head 112, and the confirmation value generation logic 111 generates a current confirmation value. If the confirmation value was stored in the memory 126, tamper detection logic 113 may read the stored confirmation value from the memory 126 via the read/write bus 125, the drive interface 124, and the cartridge interface 114. If the confirmation value was stored on the storage medium 121, the tamper detection logic 113 may read the stored confirmation value from the storage medium. If a data set identifier is specified, the tamper detection logic 113 may use that identifier to retrieve the stored confirmation value associated with the data set identifier. The tamper detection logic 113 performs the comparison of the current confirmation value to the stored confirmation value. If the two confirmation values are equivalent, then the data set has not been altered since the time represented by the stored time stamp. Otherwise, if the two values are not equivalent, then the data has been altered since the time represented by the time stamp associated with the data set on the storage medium. Equivalence may be determined by, e.g., an equality comparison. The result of the comparison may be presented to a user, for example, on a display attached to the media drive 110, or on a display attached to the host system 105.

The confirmation value may also be saved or transmitted externally for future comparison. As one example, a confirmation value transmitted to an external party could be used to log the creation of a data set without the risk of transmitting the original data set itself. For example, a bank could save daily transaction records on tape and transmit only the confirmation code to a regulatory agency. Such transmission would not expose the original data to risk of interception, but would provide the regulatory agency with some assurance that data sets reproduced on demand in the future, e.g., as part of an audit, were in fact created at the time claimed, because the calculated confirmation code matches the code transmitted previously.

As described above, a confirmation value may be associated with a data set when the data set is written to the storage medium 121. According to one example, a confirmation value may also be associated with a previously-written data set in response to a user's request, or in response to an event, such as a request from the host system 105. With respect to FIG. 1, to associate a confirmation value with a previously-written data set, the confirmation value generation logic 111 reads the previously written data set from the storage medium 121 using the read/write head 112 and generates a confirmation value for the previously-written data set. The confirmation value is then stored in the confirmation value memory location 128 or on the storage medium 121, and an associated time stamp is stored on the storage medium 121. According to one example, a confirmation value may be associated with a data set multiple times, in which case the most recent confirmation value and time stamp may be stored in the memory 126, but previous confirmation values and time stamps may be discarded from the memory 126. According to other examples, a data set may have multiple versions, and a confirmation value and timestamp may be associated with each version, so that when a particular version is retrieved, the authenticity of the version can be verified using the confirmation value and timestamp associated with that version.

The data set, time stamp, and optional confirmation value may be stored in such a way that an association between the values and the data set is present on the storage medium 121 to provide for subsequent retrieval of the time stamp and optional confirmation value associated with a desired data set. For example, the data set, time stamp, and optional confirmation value may be stored in locations relative to each other in accordance with a predetermined format.

As described above, in one example, a confirmation value associated with a data set may be stored in the memory 126 associated with the media carrier 120, in which case the confirmation value is stored in a confirmation value memory location 128. The data set identifier, if specified, may be stored in a data set identifier memory location 127. If the data set identifier is specified, then, to allow subsequent retrieval of the confirmation value associated with a desired data set, the identifier may be stored in a memory location relative to the confirmation value according to a predetermined format, or an association may created in the memory 126 between the confirmation value and the data set identifier. The association may be represented in the memory 126 as, for example, an entry in a lookup table. In one example, a time stamp may be stored explicitly in the memory 126. A time stamp memory location is not shown in the example of FIG. 1 because the stored confirmation value in that example is based in part on the time stamp, and the time stamp stored on the storage medium 121 may be used to determine the time at which the corresponding data set was stored.

The confirmation value preferably has the following property: given a data set and corresponding confirmation value, it should be difficult to find a second data set for which the same confirmation value will be generated. The function may be, for example, a function that calculates a Cyclic Redundancy Check (CRC) value for the data. In other examples, the function may be a cryptographic hash function, as is known in the art. The function may take data of any length as input and produce a fixed-length value. The function that generates the confirmation value may be used with any other techniques known in the art to enhance the confirmation value's resistance to attacks such as attempts to find a second data set with the same confirmation value as the data stored on the storage medium.

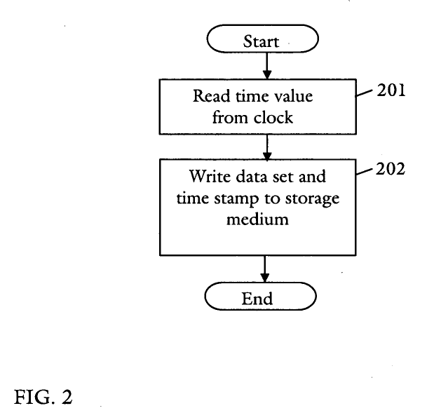

FIG. 2 is a flowchart illustrating a method of writing data to a storage medium according to one example. In block 201, when a process for writing a data set is initiated, a time stamp is generated by reading a clock associated with the storage medium. In block 202, the data set and time stamp are written to the storage medium. The method of FIG. 2 may be performed, for example, by a media drive in cooperation with a clock-equipped media carrier.

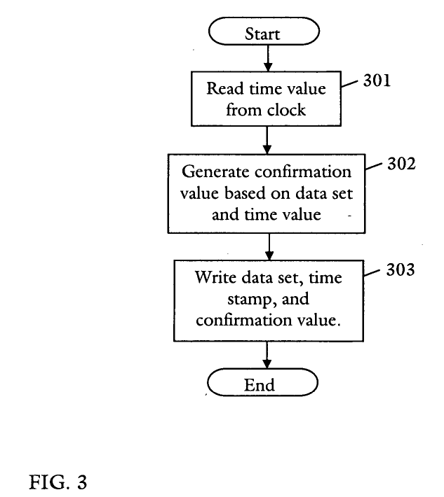

FIG. 3 is a flowchart illustrating a method of writing data to a storage medium according to one example. In block 301, when a data set is written, a time value is read from a clock associated with the storage medium. In block 302, a confirmation value is generated based upon the data set and the time value. In other examples, the confirmation value may be based upon the data set but not the time value, or on the data set and other values. In block 303, the data set, time stamp, and confirmation value are written to the storage medium in such a way that the time stamp and confirmation value are associated with the data set and can be retrieved when the data set is retrieved. The time value is written to the storage medium to form the time stamp. The method of FIG. 3 may be performed, for example, by a memory-equipped media drive in cooperation with a clock-equipped media carrier.

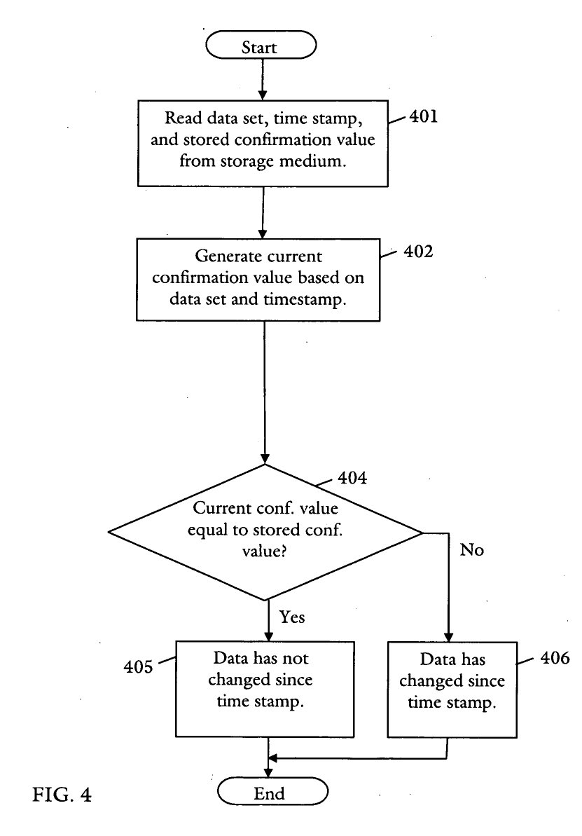

FIG. 4 is a flowchart illustrating a method of checking for modification of a stored data set according to one example. In block 401, in response to such a request, a data set and associated time stamp and confirmation value are read from a storage medium. The confirmation value was generated based upon the contents of the data set and the time stamp at the time represented by the time stamp, e.g., as described herein. In block 402, a current confirmation value is generated based upon the time stamp and the contents of the data set currently stored on the storage medium. In other examples, the current confirmation value may be based upon the data set but not the time stamp, or on the data set and other values. In block 404, the stored confirmation value is compared to the current confirmation value. If the two confirmation values are equal, then the data has not been altered since the time represented by the time stamp, and a corresponding action is performed in block 405. If the values are not equal, then the data has been altered since the time stamp, and a different corresponding action is performed in block 406. The method of FIG. 4 may be performed, for example, by a media drive in cooperation with a media carrier.

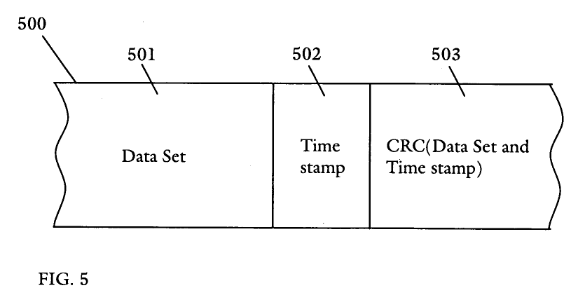

FIG. 5 is an illustrative drawing of a data set and associated values stored on a storage medium, e.g., magnetic tape, according to one embodiment of the invention. A data set 501, an associated time stamp 502, and an associated stored confirmation value 503 are stored on a magnetic tape 500. The time stamp 502 and the confirmation value 503 may be written to the tape 500 by, for example, the method of FIG. 3 and may be read, for example, by the method of FIG. 5, to determine if the data set 501 has been modified since the time represented by the time stamp 502. The confirmation value 503 may be determined by a CRC or message digest function of the data set 501 and the time stamp 502. The physical layout shown in FIG. 5, in which the time stamp 502 follows the data set 501, and the confirmation value 503 follows the time stamp 502, establishes an association between the data set 501, the time stamp 502, and the confirmation value 503 on the tape 500, so that the method of FIG. 5 can retrieve the time stamp 502 and the confirmation value 503 associated with the data set 501. If a tape 500 contains multiple data sets, each data set would be followed by its associated time stamp and confirmation value. Other ways of associating the timestamp and confirmation value with the data set are possible. For example, the time stamp and confirmation value could be stored in an index associated with but not stored adjacent to the data set.

The time stamp generated by a clock included with the media carrier solves the problem of determining when a data set was written by ensuring that time stamp values written to the storage medium are accurate. The confirmation value provides an added guarantee that the data set has not been modified since it was written, because any change to the data set will be detected, with a high degree of certainty, when the authenticity of the data set is checked by generating a new confirmation value and comparing the new confirmation value to the stored confirmation value. The stored confirmation value may also provide a strong guarantee that the time stamp is accurate, because the stored time stamp is included in the calculation of the stored confirmation value, and is also included in the calculation of the new confirmation value. The guarantee is strong because it would be very difficult to derive a second, substitute data set that, when combined with the old time stamp, produces the same confirmation value.

The above detailed description is provided to illustrate exemplary embodiments and is not intended to be limiting. It will be apparent to those of ordinary skill in the art that numerous modifications and variations within the scope of the present invention are possible. Additionally, particular examples have been discussed and how these examples are thought to be advantageous or address certain disadvantages in related art. This discussion is not meant, however, to restrict the various examples to methods and/or systems that actually address or solve the disadvantages.

What is claimed is:

1. A media carrier comprising:
a storage medium;
clock logic for generating a time value readable by a media drive; and
a battery for powering the clock logic.

2. The media carrier of claim 1, wherein the storage medium comprises tape.

3. The media carrier of claim 1, wherein the clock logic comprises a clock that is not resettable by a user of the media carrier, wherein the battery is operable to power the clock for at least 1 year.

4. The media carrier of claim 1, further comprising:
a memory having a data set identifier memory location for storing a data set identifier.

5. The media carrier of claim 1, further comprising:
a memory having a confirmation value memory location for storing a confirmation value.

6. The media carrier of claim 5, wherein the memory is nonvolatile.

7. The media carrier of claim 5, wherein the memory is a Programmable Read-Only Memory (PROM).

8. A media drive for operation with a media carrier, the media carrier including clock logic for generating a time value, the media drive comprising:
time stamp recording logic for reading the time value from the media carrier and creating a time stamp on a storage medium associated with the media carrier, wherein the time stamp is based upon the time value, and the time stamp is associated with a data set written to the storage medium.

9. The media drive of claim 8, wherein the time stamp is based upon the time the data set is written to the storage medium.

10. The media drive of claim 8, further comprising:
confirmation value generation logic for generating a confirmation value based upon the data set; and
confirmation value recording logic for writing the confirmation value to the storage medium, wherein the confirmation value is associated with the data set.

11. The media drive of claim 10, wherein the confirmation value is based upon the data set and the time stamp.

12. The media drive of claim 10, wherein the confirmation value is generated by a function based upon the data set and the time stamp.

13. The media drive of claim 10, wherein the confirmation value includes a Cyclic Redundancy Check value based upon the data set.

14. The media drive of claim 10, further comprising:
tamper detection logic operable to compare a current confirmation value generated by the confirmation value generation logic based upon a stored data set stored on the storage medium to a stored confirmation value read from the storage medium, wherein the stored confirmation value is associated with the stored data set.

15. The media drive of claim 14, wherein the tamper detection logic is operable to report tampering if the current confirmation value is not equivalent to the stored confirmation value.

16. A tape cartridge, comprising:
a tape;
a battery; and
a clock for generating a time value, wherein the clock is powered by the battery.

17. The tape cartridge of claim 16, further comprising a drive interface operable to send the time value to a tape drive.

18. The tape cartridge of claim 16, further comprising:
a memory having a confirmation value memory location for storing a confirmation value.

19. A tape drive for operation with a tape cartridge, the tape cartridge including clock logic for generating a time value, the tape drive comprising:
a cartridge interface operable to receive a time value from the tape cartridge; and
time stamp recording logic for reading the time value from the cartridge interface and creating a time stamp on a tape associated with the tape cartridge, wherein the time stamp is based upon the time value, and the time stamp is associated with a data set written to the tape.

20. The tape drive of claim 19, further comprising:
confirmation value generation logic for generating a confirmation value based upon the data set; and
confirmation value recording logic for writing the confirmation value to the tape, wherein the confirmation value is associated with the data set.

21. The tape drive of claim 19, wherein the cartridge interface is further operable to send a confirmation value to the tape cartridge, and the tape cartridge further includes a memory having a confirmation value memory location, the tape drive further comprising:
confirmation value generation logic for generating a confirmation value based upon the data set; and
confirmation value storage logic operable to send the confirmation value to the tape cartridge via the cartridge interface for storage in the confirmation value memory location.

22. A method for storing a data set on a storage medium, wherein the storage medium is associated with a media carrier, comprising the steps of:
reading a time value from a clock associated with the media carrier;
creating a time stamp on the storage medium, wherein the time stamp is based upon the time value; and
writing the data set to the storage medium, wherein the data set is associated with the time stamp.

23. The method of claim 22, further comprising the step of:
generating a confirmation value based upon the data set; and
writing the confirmation value to the storage medium.

24. A method for determining when a data set was written to a storage medium, comprising the step of:
reading from the storage medium a time stamp associated with the data set.

25. The method of claim 24, further comprising the steps of:
generating a current confirmation value based upon the data set;
retrieving from a memory a stored confirmation value;
comparing the current confirmation value to the stored confirmation value; and
if the values are equivalent, reporting that the data set was written at the time corresponding to the time stamp.
